(19) United States
(12) Patent Application Publication
(10) Pub. No.: US 2022/0019235 A1
(43) Pub. Date: Jan. 20, 2022

(54) ROUTE SEARCH SUPPORT APPARATUS, ROUTE SEARCH SUPPORT METHOD, AND COMPUTER-READABLE RECORDING MEDIUM

(71) Applicant: NEC Corporation, Minato-ku, Tokyo (JP)

(72) Inventors: Manao MACHIDA, Tokyo (JP); Naoto OHSAKA, Tokyo (JP)

(73) Assignee: NEC Corporation, Minato-ku, Tokyo (JP)

(21) Appl. No.: 17/296,616

(22) PCT Filed: Nov. 29, 2018
(86) PCT No.: PCT/JP2018/044073

§ 371 Date: May 25, 2021

(51) Int. Cl. G05D 1/02; G01C 21/20

(52) U.S. Cl. CPC G05D 1/0287; G01C 21/206; G05D 1/0274

(57) ABSTRACT

A route search support apparatus 10 is an apparatus for supporting a search for a route of multiple moving objects that move independently in a specific area. The search support apparatus 10 includes an information acquisition unit 11 that acquire a map information of the specific area and a task point information that specifies a task point at which the moving objects executes a task in the specific area, and an escape point setting unit 12 that set an escape point at which the moving object escape based on the map information and the task point information, so that the escape point does not exist on a route between task points in the specific area.

### TECHNICAL FIELD

The present invention relates to a route search support apparatus and a route search support method for supporting the route search of a moving object that moves independently, and further relates to a computer-readable medium that includes recorded thereon a program for realizing the route search support apparatus and the route search support method.

### BACKGROUND ART

Conventionally, automatic guided vehicles (AGVs) have been introduced in various factories in order to improve work efficiency and production efficiency. In addition, automatic guided vehicles have been introduced at distribution bases in order to realize quick delivery.

In general, the number of automatic guided vehicles operating in factories, distribution bases, etc. is not one but a plurality. Therefore, when operating multiple automatic guided vehicles, in order to prevent collisions as much as possible, an automated guided vehicle without luggage (hereinafter referred to as “vacant vehicle”) stands by at an escape point. (see Patent Document 1)

Specifically, Patent Document 1 discloses an operation system for a plurality of automatic guided vehicles. The operation system disclosed in Patent Document 1 first executes detection of vacant traveling vehicles, and if vacant traveling vehicles can be detected, sets the same number of escape points as the detected number.

Next, the operation system disclosed in Patent Document 1 searches for a route from the set escape point to the detected vacant vehicle. Then, the operation system gives an instruction to the vacant vehicle for which the route has been searched to move along the searched route when another vacant vehicle does not exist in the searched route. On the other hand, if there is another vacant vehicle in the searched route, the operation system instructs the other vacant vehicle to move along the searched route.

As described above, according to the operation system disclosed in Patent Document 1, all the vacant traveling vehicles are evacuated at the escape point.

As a result, the occurrence of collisions between automatic guided vehicles is suppressed.

### LIST OF RELATED ART DOCUMENTS

### Patent Document

Patent Document 1: JP2016-81378A

### SUMMARY OF INVENTION

### Problems to be Solved by the Invention

The system disclosed in Patent Document 1 set the escape points by selecting the escape points as many as the number of vacant vehicles according to a certain rule from among escape point candidates preset by humans. For this reason, the manager of the operation system needs to set a new escape point candidate each time the layout of the factory or the like changes. And, the layout may be changed frequently, and the setting of the escape point candidate may be a burden for the manager.

An example of an object of the present invention is a route search support apparatus and a route search support method and a computer-readable recording medium that solve the above-problems and make it possible to set an escape point necessary for the route search of a moving object that moves independently without relying on manual settings.

### Means for Solving the Problems

In order to achieve the above-described object, a route search support apparatus according to an example aspect of the invention is an apparatus for supporting a search for a route of multiple moving objects that move independently in a specific area, and includes:

an information acquisition unit configured to acquire a map information of the specific area and a task point information that specifies a task point at which the moving object executes a task in the specific area; and an escape point setting unit configured to set an escape point at which the moving object escape based on the map information and the task point information, so that the escape point does not exist on the route between task points in the specific area.

In addition, in order to achieve the above-described object, a route search support method according to an example aspect of the invention is a method for supporting a search for a route of multiple moving objects that move independently in a specific area, and includes:

(a) a step of acquiring a map information of the specific area and a task point information that specifies a task point at which the moving object executes a task in the specific area; and

(b) a step of setting an escape point at which the moving object escape based on the map information and the task point information, so that the escape point does not exist on the route between task points in the specific area.

Furthermore, in order to achieve the above-described object, a computer readable recording medium according to an example aspect of the invention is a computer readable recording medium that includes recorded thereon a program for supporting a search for a route of multiple moving objects that move independently in a specific area by means of a computer, the program including instruction that cause the computer to carry out:

(a) a step of acquiring a map information of the specific area and a task point information that specifies a task point at which the moving object executes a task in the specific area; and

(b) a step of setting an escape point at which the moving object escape based on the map information and the task point information, so that the escape point does not exist on the route between task points in the specific area.

### Advantageous Effects of the Invention

As described above, according to the invention, it is possible to set an escape point necessary for the route search of a moving object that moves independently without relying on manual settings.

### BRIEF DESCRIPTION OF THE DRAWINGS

FIG. 1 is a block diagram illustrating a schematic configuration of a route search support apparatus according to a first example embodiment of the present invention.

FIG. 2 is a block diagram illustrating a specific configuration of the route search support apparatus according to the first example embodiment of the present invention.

FIG. 3 is a diagram schematically illustrating an example of a map information of an area in which a moving object moves in the first example embodiment of the present invention.

FIG. 4A to 4E are diagrams for explaining the process of setting the escape point in the first example embodiment of the present invention.

FIG. 5 is a flow chart illustrating the operation of the route search support apparatus according to the first example embodiment of the present invention.

FIG. 6A to 6C are diagrams for explaining the process of setting the escape point in the second example embodiment of the present invention.

FIG. 7 is a flow chart illustrating the operation of the route search support apparatus according to the second example embodiment of the present invention.

FIG. 8 is a block diagram illustrating an example of a computer that realizes the route search support apparatus according to the first and second example embodiments of the present invention.

### EXAMPLE EMBODIMENT

### First Example Embodiment

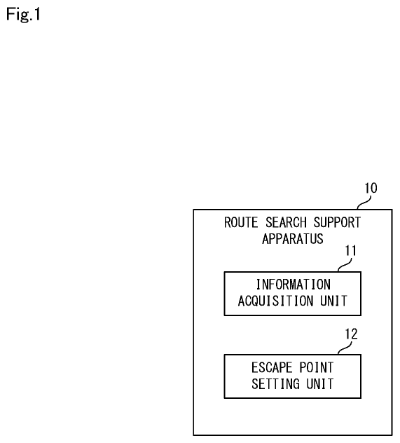

In the following, a route search support apparatus, route search support method, and a program in first example embodiment of the present invention will be described with reference to FIGS. 1 to 5.

[Apparatus Configuration]

First, a schematic configuration of the route search support apparatus in the first example embodiment will be described with reference to FIG. 1. FIG. 1 is a block diagram illustrating a schematic configuration of a route search support apparatus according to a first example embodiment of the present invention.

A route search support apparatus 10 according to the first example embodiment shown in FIG. 1, is an apparatus for supporting a search for a route of multiple moving objects that move independently in a specific area. Examples of the moving object include an automatic guided vehicle, a robot, and the like. In addition, examples of the specific area include factories, warehouses, and the like.

Further, as shown in FIG. 1, the route search support apparatus 10 includes an information acquisition unit 11 and an escape point setting unit 12. The information acquisition unit 11 acquires a map information of the specific area and a task point information. The task point information is information that specifies a task point at which the moving object executes a task in the specific area. The escape point setting unit 12 sets an escape point at which the moving object can escape based on the map information and the task point information, so that the escape point does not to exist on a route between task points in the specific area.

As described above, in the first example embodiment, the escape point of the moving object is automatically set by using the map information of the specific area and the task point information. That is, according to the first example embodiment, it is possible to set an escape point necessary for the route search of the moving object that moves independently without relying on manual settings.

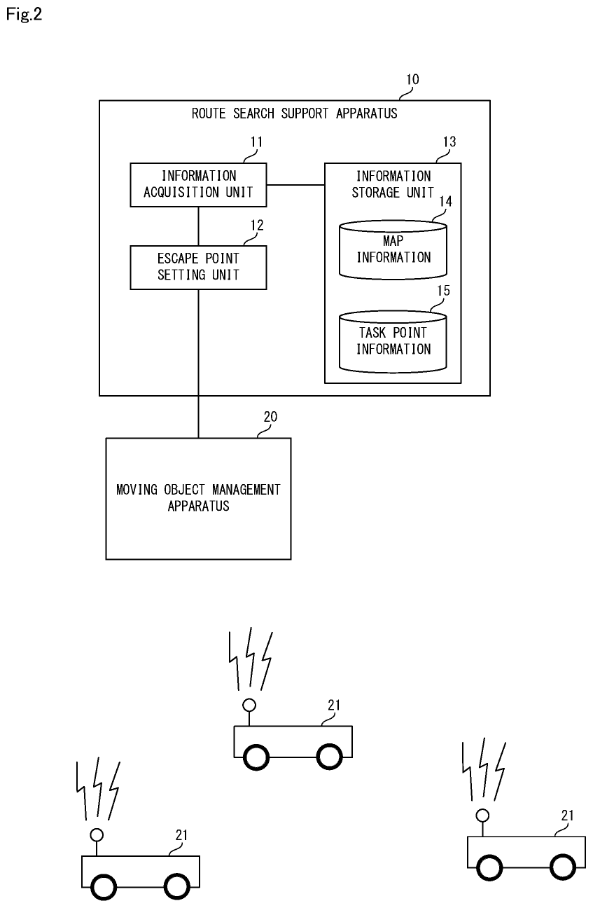

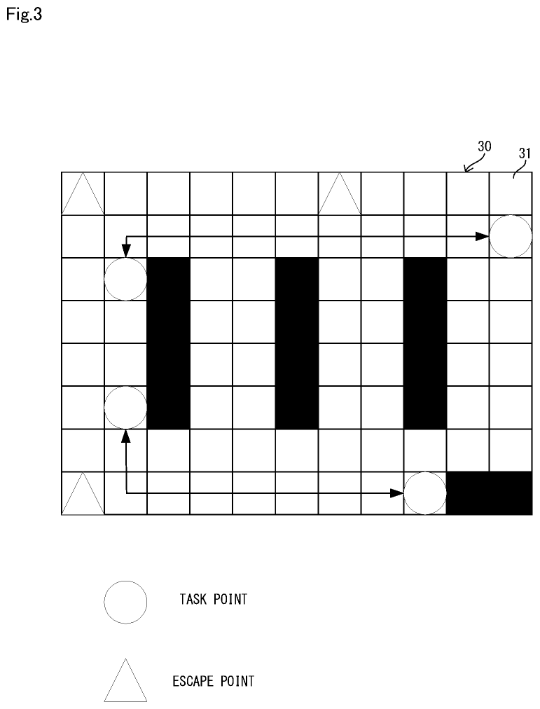

Here, the configuration and function of the route search support apparatus 10 according to the first example embodiment will be described more specifically with reference to FIGS. 2 to 4. FIG. 2 is a block diagram illustrating a specific configuration of the route search support apparatus according to the first example embodiment of the present invention. FIG. 3 is a diagram schematically illustrating an example of map information of an area in which a moving object moves in the first example embodiment of the present invention.

As shown in FIG. 2, the route search support apparatus 10 is connected to the moving object management apparatus 20 that manages the moving object 21 so that data communication is possible. In the example of FIG. 2, the moving object 21 is an automatic guided vehicle. The moving object management apparatus 20 and each moving object 21 are connected so as to be capable of data communication by wireless communication. In the first example embodiment, the route search support apparatus 10 may be mounted on the moving object management apparatus 20.

When the route search support apparatus 10 sets the escape point, the route search support apparatus 10 notifies the moving object management apparatus 20 of the set escape point. Upon receiving the notification of the escape point, the moving object management apparatus 20 notifies each moving object 21 of the route and the escape point.

Further, as shown in FIG. 2, in the first example embodiment, the route search support apparatus 10 includes an information storage unit 13 in addition to the information acquisition unit 11 and the escape point setting unit 12 described above. The information storage unit 13 stores a map information 14 and a task point information 15.

In the first example embodiment, as shown in FIG. 3, the area 30 in which the moving object 21 moves is divided in a grid pattern and is composed of a plurality of grids 31. The map information is composed of an information for each grid 31. In the example of FIG. 3, devices, shelves, etc. are arranged on the filled grid. Task points, routes and escape points are set on the unfilled grid 31.

In the first example embodiment, the task point information is information for specifying the position (coordinates, serial number, etc.) of the grid corresponding to the actual task point. In the first example embodiment, the escape point setting unit 12 sets the escape point by selecting a grid to be the escape point.

Further, in the first example embodiment, the escape point setting unit 12 sets the escape point by using the minimum Steiner tree algorithm. That is, the escape point setting unit 12 specifies a route that connects all the task points and minimizes a number of the grids included and selects the grid to be the escape point from grids other than the grid on the specified route. The Steiner tree algorithm in the first example embodiment is an example and is an approximation algorithm. In the first example embodiment, another Steiner tree algorithm may be used.

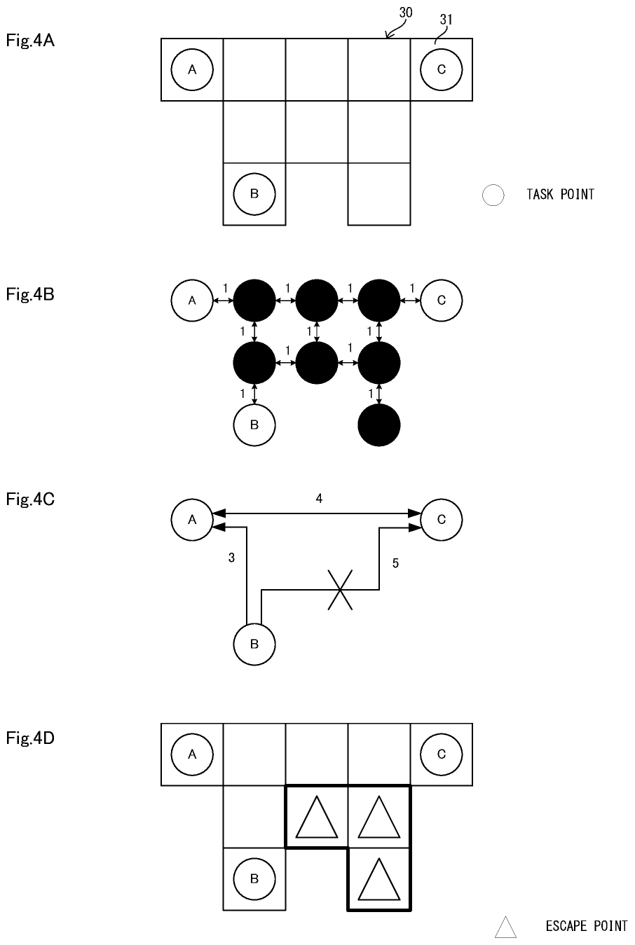

The setting process of the escape point by the escape point setting unit 12 in the first example embodiment will be specifically described with reference to FIG. 4. FIG. 4A to 4E are diagrams for explaining the process of setting the escape point in the first example embodiment of the present invention.

First, it is assumed that the area 30 shown in FIG. 4A exists, and three task points A to B are set there. Further, in FIG. 4A, assuming that each grid 31 is a node, the area shown in FIG. 4A can be represented as shown in FIG. 4B. Further, the numerical values shown in FIG. 4B indicate a cost of moving between grids. Further, in FIG. 4B, the nodes of the grid other than the task point are indicated by “black circle”.

Then, it is assumed that the escape point setting unit 12 searches for a route connecting all the task points by the moving object 21. In this case, the escape point setting unit 12 searches for a route of B->A->C and a route of B->C->A.

Subsequently, the escape point setting unit 12 specifies a route that minimizes the number of included grids, but in the first example embodiment, the route is specified by approximating the “number of included grids” with the route length. Therefore, since the route length of the former is 7 (=3+4) and the route length of the latter is 9 (=5+4), the refuge point setting unit 12 specified the route B->A->C as the route that minimizes the number of grids included. As a result, the route B->C is not adopted, and the escape point setting unit 12 selects the grid 31 at a location indicated by the frame line in FIG. 4C as the escape point. After that, the escape point setting unit 12 notifies the moving object management apparatus 20 of the selected grid 31 (escape point).

[Apparatus Operations]

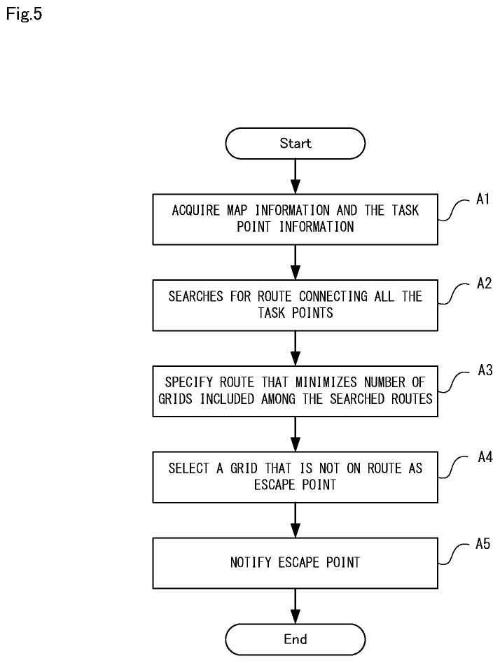

Next, the operations of the route search support apparatus 10 in the first example embodiment will be described with reference to FIG. 5. FIG. 5 is a flow chart illustrating the operation of the route search support apparatus according to the first example embodiment of the present invention. FIGS. 1 to 4 will be referred to as needed in the following description. Furthermore, in the first example embodiment, a route method is implemented by causing the route apparatus 10 to operate. Accordingly, the following description of the operations of the route search support apparatus is substituted for the description of the route search support method in the first example embodiment.

First, as shown in FIG. 5, the information acquisition unit 11 acquires the map information of the specific area and the task point information from the information storage unit 13 (step A1).

Next, the escape point setting unit 12 searches for a route connecting all the task points based on the map information and the task point information (step A2). Then, the escape point setting unit 12 specifies a route that minimizes the number of grids included, for example, a route that minimizes a route length, among the searched routes (step A3).

Next, the escape point setting unit 12 selects a grid that is not on the route specified in step A3 as an escape point (step A4). After that, the escape point setting unit 12 notifies the moving object management apparatus 20 of the grid selected as the escape point (step A5).

In this way, when steps A1 to A5 are executed, an escape point at which the moving object can be shunted is set so as not to exist on the route between the task points in the specific area 30. According to the first example embodiment, it is possible to set an escape point necessary for route search of a moving object 21 that moves independently without relying on manual settings.

[Program]

It is sufficient for the program according to the first example embodiment to be a program that causes a computer to execute steps A1 to A5 shown in FIG. 5. The route search support apparatus and the route search support method according to the first example embodiment can be realized by installing this program in the computer and executing this program. In this case, a processor of the computer functions as the information acquisition unit 11 and the escape point setting unit 12 and performs processing. Also, the information storage unit 13 is realized by storing a data file constituting these in a storage device, such as a hard disk provided in the computer that executes the above program or external another computer.

Furthermore, the program according to the first example embodiment may be executed by a computer system constructed with a plurality of computers. In this case, for example, each computer may function as one of the information acquisition unit 11 and the escape point setting unit 12.

### Second Example Embodiment

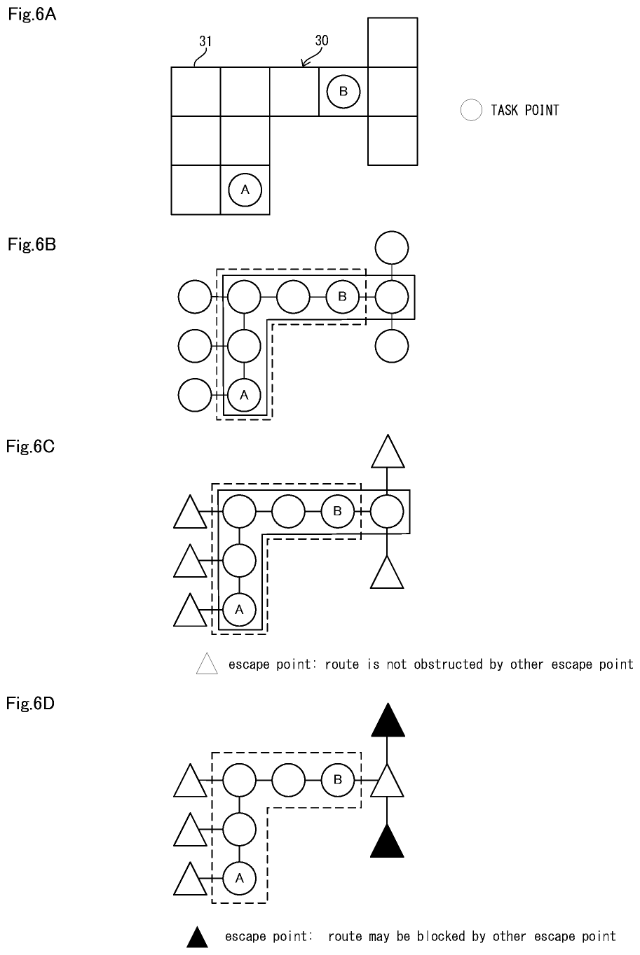

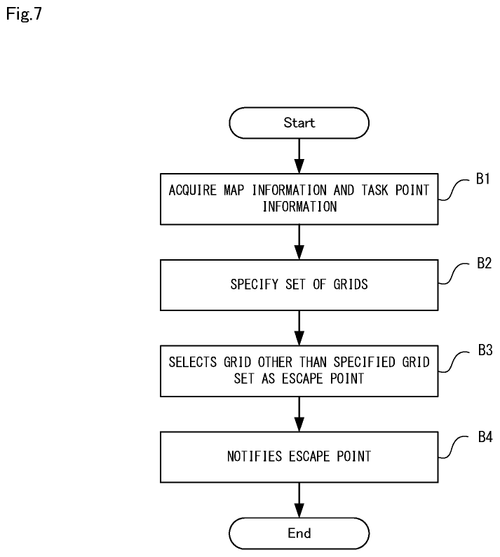

Next, a route search support apparatus, route search support method, and a program in second example embodiment of the present invention will be described with reference to FIGS. 6 and 7.

The route search support apparatus according to the second example embodiment has the same configuration as the route search support apparatus 10 according to the first example embodiment shown in FIGS. 1 and 2. However, in the second example embodiment, the function of the escape point setting unit is different from that of the first example embodiment. Hereinafter, the differences from the first example embodiment will be mainly described. Further, in the following description, FIGS. 1 to 4 will be referred to as appropriate.

In the second example embodiment, the escape point setting unit 12 selects a grid to be an escape point by using the minimum connected dominating set. That is, the escape point setting unit 12 sets a set of grids including and connected to two or more task points and selects the grid to be the escape point from grids other than the set of grids.

The setting process of the escape point by the escape point setting unit 12 in the second example embodiment will be specifically described with reference to FIG. 6. FIG. 6A to 6C are diagrams for explaining the process of setting the escape point in the second example embodiment of the present invention.

First, it is assumed that the area 30 shown in FIG. 6A exists, and two task points A and B are set there. Further, in FIG. 6A, assuming that each grid 31 is a node, the area shown in FIG. 6A can be represented as shown in FIG. 6B. Further, in FIG. 6B, the nodes of the grid other than the task point are indicated by “white circle”.

Then, as shown in FIG. 6B, the escape point setting unit 12 specifies a grid set including two or more task points (task points A and B in the example of FIG. 6) among the plurality of grids 31. In FIG. 6B, the border indicates the specified grid set. Moreover, in the grid set, each grid is connected. Here, “connected” means that the moving object 21 can move back and forth between arbitrary grids in the set only through the grids included in the set.

Then, as shown in FIG. 6C, the escape point setting unit 12 sets a grid other than the specified grid set as the escape point. In FIG. 6C, “non filled triangle” is the escape point. In particular, the escape point “non filled triangle” is an escape point where the route is not obstructed by other escape point,

The grid set is not particularly limited as long as it includes all the task points, and each grid is connected. Therefore, in the example of FIG. 6B, it is also possible to specify the grid set so as to be surrounded by the frame line shown by the broken line. In this case, as shown in FIG. 6D, an escape point is selected. In FIG. 6D, “non filled triangle” and “filled triangle” are escape points, and “filled triangle” is an escape point where the route may be blocked by other escape point.

Further, as shown in FIG. 6D, when the grid set is specified by the frame line shown by the broken line, the number of escape points “non filled triangle” whose route is not blocked by other escape points is smaller than that when the grid set is specified by the frame line indicated by the solid line. Therefore, in the example of FIG. 6B, the grid set is specified as shown by the solid line.

[Apparatus Operations]

Next, the operations of the route search support apparatus in the second example embodiment will be described with reference to FIG. 7. FIG. 5 is a flow chart illustrating the operation of the route search support apparatus according to the second example embodiment of the present invention. FIGS. 1 to 4 will be referred to as needed in the following description. Furthermore, in the second example embodiment, a route method is implemented by causing the route apparatus to operate. Accordingly, the following description of the operations of the route search support apparatus is substituted for the description of the route search support method in the second example embodiment.

First, as shown in FIG. 5, the information acquisition unit 11 acquires the map information of the specific area and the task point information from the information storage unit 13 (step B1).

Next, the escape point setting unit 12 specifies a set of grids (grid set) that includes and connects two or more task points among the plurality of grids 31, (Step B2).

Next, the escape point setting unit selects a grid other than the specified grid set as the escape point (Step B3). After that, the escape point setting unit 12 notifies the moving object management apparatus 20 of the grid as the escape point (step B4).

In this even when steps B1 to B4 are executed, an escape point is set in the specific area 30. Also, in the case of the second example embodiment, it is possible to set an escape point necessary for route search of the moving object 21 that moves independently without relying on manual settings.

[Program]

It is sufficient for the program according to the second example embodiment to be a program that causes a computer to execute steps B1 to B4 shown in FIG. 7. The route search support apparatus and the route search support method according to the second example embodiment can be realized by installing this program in the computer and executing this program. In this case, a processor of the computer functions as the information acquisition unit 11 and the escape point setting unit 12 and performs processing. Also, the information storage unit 13 is realized by storing a data file constituting these in a storage device, such as a hard disk provided in the computer that executes the above program or external another computer.

Furthermore, the program according to the second example embodiment may be executed by a computer system constructed with a plurality of computers. In this case, for example, each computer may function as one of the information acquisition unit 11 and the escape point setting unit 12.

(Physical Configuration)

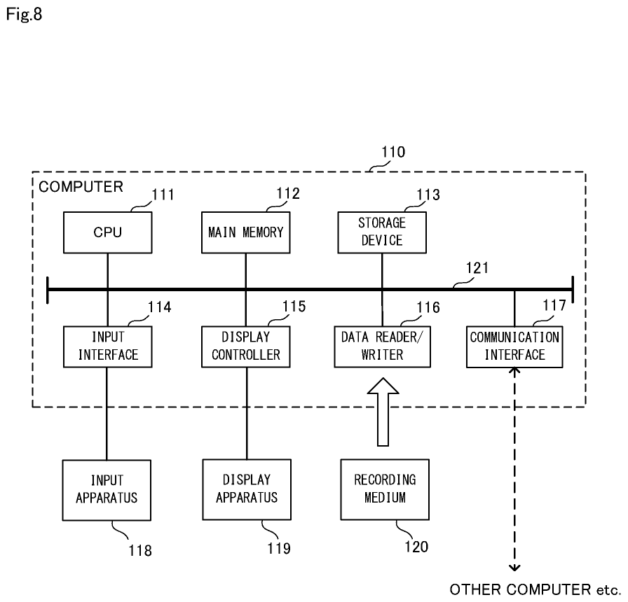

Using FIG. 8, the following describes a computer that realizes the route search support apparatus by executing the program according to the present example embodiment. FIG. 8 is a block diagram showing an example of a computer that realizes the route search support apparatus according to the first and second example embodiment of the present invention.

As shown in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121. Note that the computer 110 may include a GPU (Graphics Processing Unit) or an FPGA (Field-Programmable Gate Array) in addition to the CPU 111, or in place of the CPU 111.

The CPU 111 carries out various types of calculation by deploying the program (codes) according to the present example embodiment stored in the storage device 113 to the main memory 112, and executing the codes in a predetermined order. The main memory 112 is typically a volatile storage device, such as a DRAM (dynamic random-access memory). Also, the program according to the present example embodiment is provided in a state where it is stored in a computer-readable recording medium 120. Note that the program according to the present example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the route search support apparatus according to the first and second example embodiment can also be realized by using items of hardware that respectively correspond to the components, rather than the computer in which the program is installed. Furthermore, a part of the route search support apparatus may be realized by the program, and the remaining part of the route search support apparatus may be realized by hardware.

A part or an entirety of the above-described example embodiment can be represented by (Supplementary Note 1) to (Supplementary Note 12) described below but is not limited to the description below.

(Supplementary Note 1)

A route search support apparatus for supporting a search for a route of multiple moving objects that move independently in a specific area, including:

an information acquisition unit configured to acquire a map information of the specific area and a task point information that specifies a task point at which the moving object executes a task in the specific area; and

an escape point setting unit configured to set an escape point at which the moving object escape based on the map information and the task point information, so that the escape point does not exist on the route between task points in the specific area.

(Supplementary Note 2)

The route search support apparatus according to Supplementary Note 1, wherein

the map information is composed of an information for each of a plurality of grids obtained by dividing the specific area in a grid pattern,

the task point information specifies a location of the grid corresponding to the task point,

the escape point setting unit sets the escape point by selecting the grid to be the escape point.

(Supplementary Note 3)

The route search support apparatus according to Supplementary Note 1, wherein the escape point setting unit specifies a route that connects all the task points and minimizes a number of the grids included and selects the grid to be the escape point from grids other than the grid on the specified route.

(Supplementary Note 4)

The route search support apparatus according to Supplementary Note 2, wherein the escape point setting unit sets a set of grids including and connected to all the tasks point and selects the grid to be the escape point from grids other than the set of grids.

(Supplementary Note 5)

A route search support method for supporting a search for a route of multiple moving objects that move independently in a specific area, comprising:

(a) a step of acquiring a map information of the specific area and a task point information that specifies a task point at which the moving object executes a task in the specific area; and

(b) a step of setting an escape point at which the moving object escape based on the map information and the task point information, so that the escape point does not exist on the route between task points in the specific area.

(Supplementary Note 6)

The route search support method according to Supplementary Note 5, wherein

the map information is composed of an information for each of a plurality of grids obtained by dividing the specific area in a grid pattern,

the task point information specifies a location of the grid corresponding to the task point,

in the (b) step, the escape point is set by selecting the grid to be the escape point.

(Supplementary Note 7)

The route search support method according to Supplementary Note 6, wherein

in the (b) step, a route that connects all the task points and minimizes a number of the grids included is specified and the grid to be the escape point is selected from grids other than the grid on the specified route.

(Supplementary Note 8)

The route search support method according to Supplementary Note 6, wherein

in the (b) step, a set of grids including and connected to all the tasks point is set and the grid to be the escape point is selected from grids other than the set of grids.

(Supplementary Note 9)

A computer-readable medium that includes recorded thereon a program for supporting a search for a route of multiple moving objects that move independently in a specific area by means of a computer,

the program including instruction that cause the computer to carry out:

(a) a step of acquiring a map information of the specific area and a task point information that specifies a task point at which the moving object executes a task in the specific area; and

(b) a step of setting an escape point at which the moving object escape based on the map information and the task point information, so that the escape point does not exist on the route between task points in the specific area.

(Supplementary Note 10)

The computer-readable medium according to Supplementary Note 9, wherein

the map information is composed of an information for each of a plurality of grids obtained by dividing the specific area in a grid pattern,

the task point information specifies a location of the grid corresponding to the task point,

in the (b) step, the escape point is set by selecting the grid to be the escape point.

(Supplementary Note 11)

The computer-readable medium according to Supplementary Note 10, wherein in the (b) step, a route that connects all the task points and minimizes a number of the grids included is specified and the grid to be the escape point is selected from grids other than the grid on the specified route.

(Supplementary Note 12)

The computer-readable medium according to Supplementary Note 10, wherein

in the (b) step, a set of grids including and connected to all the tasks point is set and the grid to be the escape point is selected from grids other than the set of grids.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to set an escape point necessary for the route search of a moving object that moves independently without relying on manual settings. The present invention is useful, for example, in a management system of an automated guided vehicle.

### REFERENCE SIGNS LIST

10 route search support apparatus
11 information acquisition unit
12 escape point setting unit
13 information storage unit
14 map information
15 task point information
20 moving object management apparatus
21 moving object
30 area
31 grid
110 computer
111 CPU
112 main memory
113 storage device
114 input interface
115 display controller
116 data reader/writer
117 communication interface
118 input apparatus
119 display apparatus
120 recording medium
121 bus

1. A route search support apparatus for supporting a search for a route of multiple moving objects that move independently in a specific area, comprising:
an information acquisition unit configured to acquire a map information of the specific area and a task point information that specifies a task point at which the moving object executes a task in the specific area; and
an escape point setting unit configured to set an escape point at which the moving object escape based on the map information and the task point information, so that the escape point does not exist on the route between task points in the specific area.

2. The route search support apparatus according to claim 1, wherein
the map information is composed of an information for each of a plurality of grids obtained by dividing the specific area in a grid pattern,
the task point information specifies a location of the grid corresponding to the task point,
the escape point setting unit sets the escape point by selecting the grid to be the escape point.

3. The route search support apparatus according to claim 2, wherein
the escape point setting unit specifies a route that connects all the task points and minimizes a number of the grids included and selects the grid to be the escape point from grids other than the grid on the specified route.

4. The route search support apparatus according to claim 2, wherein
the escape point setting unit sets a set of grids including and connected to all the tasks point and selects the grid to be the escape point from grids other than the set of grids.

5. A route search support method for supporting a search for a route of multiple moving objects that move independently in a specific area, comprising:
(a) a step of acquiring a map information of the specific area and a task point information that specifies a task point at which the moving object executes a task in the specific area; and
(b) a step of setting an escape point at which the moving object escape based on the map information and the task point information, so that the escape point does not exist on the route between task points in the specific area.

6. The route search support method according to claim 5, wherein
the map information is composed of an information for each of a plurality of grids obtained by dividing the specific area in a grid pattern,
the task point information specifies a location of the grid corresponding to the task point,
in the (b) step, the escape point is set by selecting the grid to be the escape point.

7. The route search support method according to claim 6, wherein
in the (b) step, a route that connects all the task points and minimizes a number of the grids included is specified and the grid to be the escape point is selected from grids other than the grid on the specified route.

8. The route search support method according to claim 6, wherein
in the (b) step, a set of grids including and connected to all the tasks point is set and the grid to be the escape point is selected from grids other than the set of grids.

9. A computer-readable medium that includes recorded thereon a program for supporting a search for a route of multiple moving objects that move independently in a specific area by means of a computer,
the program including instruction that cause the computer to carry out:
(a) a step of acquiring a map information of the specific area and a task point information that specifies a task point at which the moving object executes a task in the specific area; and
(b) a step of setting an escape point at which the moving object escape based on the map information and the task point information, so that the escape point does not exist on the route between task points in the specific area.

10. The computer-readable medium according to claim 9, wherein
the map information is composed of an information for each of a plurality of grids obtained by dividing the specific area in a grid pattern,
the task point information specifies a location of the grid corresponding to the task point,
in the (b) step, the escape point is set by selecting the grid to be the escape point.

11. The computer-readable medium according to claim 10, wherein
in the (b) step, a route that connects all the task points and minimizes a number of the grids included is specified and the grid to be the escape point is selected from grids other than the grid on the specified route.

12. The computer-readable medium according to claim 10, wherein
in the (b) step, a set of grids including and connected to all the tasks point is set and the grid to be the escape point is selected from grids other than the set of grids.
